(19) United States
(12) Patent Application Publication
(10) Pub. No.: US 2026/0003113 A1
(43) Pub. Date: Jan. 1, 2026

(54) OPTICAL LAMINATE, OPTICAL LENS, AND VIRTUAL REALITY DISPLAY APPARATUS

(71) Applicant: FUJIFILM Corporation, Tokyo (JP)

(72) Inventor: Toshikazu SUMI, Minamiashigara-shi, Kanagawa (JP)

(73) Assignee: FUJIFILM Corporation, Tokyo (JP)

(21) Appl. No.: 19/318,428

(22) Filed: Sep. 4, 2025

Related U.S. Application Data
(63) Continuation of application No. PCT/JP2024/012577, filed on Mar. 28, 2024.

(30) Foreign Application Priority Data
Mar. 29, 2023 (JP) 2023-054000
Oct. 25, 2023 (JP) 2023-183146

(51) Int. Cl. G02B 5/30; G02B 27/01

(52) U.S. Cl. CPC G02B 5/3016; G02B 27/0172; G02B 2027/0114; G02B 2027/013

(57) ABSTRACT

An object of the present invention is to provide an optical laminate which includes a reflective polarizer, an absorptive polarizer, and at least one adhesive layer, and exhibits high image sharpness in a case of being bonded to a lens or the like of a virtual reality display apparatus. The optical laminate of the present invention includes a reflective polarizer, an absorptive polarizer, and at least one adhesive layer, in which, in a case where the reflective polarizer is heated for 1 minute at a temperature higher than a glass transition temperature of the reflective polarizer by 20° C., the reflective polarizer exhibits a dimensional change of a contraction of 0% or more and less than 0.8% in at least one in-plane orientation, and the reflective polarizer is a reflective linear polarizer formed by alternately laminating two or more different types of birefringent layers.

### CROSS-REFERENCE TO RELATED APPLICATIONS

This application is a Continuation of PCT International Application No. PCT/JP2024/012577 filed on Mar. 28, 2024, which claims priority under 35 U.S.C. § 119(a) to Japanese Patent Application No. 2023-054000 filed on Mar. 29, 2023 and Japanese Patent Application No. 2023-183146 filed on Oct. 25, 2023. The above applications are hereby expressly incorporated by reference, in their entirety, into the present application.

### BACKGROUND OF THE INVENTION

### 1. Field of the Invention

The present invention relates to an optical laminate, an optical lens, and a virtual reality display apparatus.

### 2. Description of the Related Art

A reflective polarizer is a polarizer having a function of reflecting one polarized light in incidence ray and transmitting the other polarized light.

An absorptive polarizer is a polarizer having a function of absorbing one polarized light in incidence ray and transmitting the other polarized light. Light absorbed by the absorptive polarizer and light transmitted through the absorptive polarizer are in a polarization state orthogonal to each other.

As a reflective linear polarizer in which transmitted light and reflected light are converted into linearly polarized light, for example, a film in which a plurality of different types of birefringent layers are alternately laminated has been known as disclosed in JP2011-053705A.

As a reflective circular polarizer in which the transmitted light and the reflected light are converted into circularly polarized light, for example, a film having a light reflecting layer obtained by immobilizing a cholesteric liquid crystalline phase has been known as disclosed in JP6277088B.

The reflective polarizer is used for a purpose of extracting only specific polarized light from incidence light or a purpose of separating incidence light into two polarized lights. However, in a case where the reflective polarizer is used alone, the separation of polarized light is often insufficient. Therefore, in many cases, an optical laminate including the reflective polarizer and the absorptive polarizer is used. In addition, another functional layer such as a retardation plate is often further laminated on the reflective polarizer.

As such an optical laminate, for example, in a liquid crystal display device, the reflective polarizer is used as a luminance-improving film which enhances light utilization efficiency by reflecting unnecessary polarized light from backlight and reusing the light. In addition, in a liquid crystal projector, the reflective polarizer is also used as a beam splitter which separates light from a light source into two linearly polarized light and supplies each of the two linearly polarized light to a liquid crystal panel.

In addition, in recent years, a method of using an optical laminate including the absorptive polarizer, the reflective polarizer, a λ/4 retardation plate, and the like has been proposed for the purpose of separating a part of light from external light or an image display device into two orthogonal polarized lights, reflecting one polarized light, and transmitting the other polarized light, thereby generating a virtual image and a real image. For example, JP6501877B discloses a method of generating a virtual image by using an optical laminate including an absorptive polarizer and a reflective polarizer to make a display unit smaller or thinner in a virtual reality display apparatus, an electronic viewfinder, or the like, reflecting light between the reflective polarizer and a half mirror to reciprocate the light, and transmitting the light through the reflective polarizer and the absorptive polarizer.

### SUMMARY OF THE INVENTION

According to the examination by the present inventors, it is found that, in the virtual reality display apparatus disclosed in JP6501877B, sharpness of a display image may be reduced.

In the virtual reality display apparatus, the image displayed by the image display device is magnified and visually recognized by the action of the optical laminate including the lens, the reflective polarizer, and the absorptive polarizer, and thus the image may be distorted by slight unevenness of the optical laminate, which may reduce the sharpness of the image.

The present invention has been made in view of the above-described problems, and an object of the present invention is to provide an optical laminate which exhibits high image sharpness in a case of being bonded to a lens or the like of a virtual reality display apparatus. Another object of the present invention is to provide an optical lens and a virtual reality display apparatus.

As a result of intensive studies repeatedly conducted by the present inventor on the above-described object, it has been found that the above-described object can be achieved by the following configurations.

[1]

An optical laminate comprising:
a reflective polarizer;
an absorptive polarizer; and
adhesive layers,
in which, in a case where the reflective polarizer is heated for 1 minute at a temperature higher than a glass transition temperature of the reflective polarizer by 20° C., the reflective polarizer exhibits a dimensional change of a contraction of 0% or more and less than 0.8% in at least one in-plane orientation, and
the reflective polarizer is a reflective linear polarizer formed by alternately laminating two or more different types of birefringent layers.
   [2]

The optical laminate according to [1],
in which the absorptive polarizer includes an anisotropic absorption layer containing at least a liquid crystal compound and a dichroic coloring agent.
   [3]

The optical laminate according to [1] or [2],
in which at least one of the adhesive layers is a layer consisting of a pressure sensitive adhesive sheet, and
the pressure sensitive adhesive sheet has a storage elastic modulus G′ of 0.8 MPa or more, which is measured by a torsional shear method at 20° C.
   [4]

The optical laminate according to any one of [1] to [3],
in which at least one of the adhesive layers is a layer formed by curing a composition for forming an adhesive layer, which contains an ultraviolet curable adhesive.
   [5]

The optical laminate according to any one of [1] to [4], further comprising:
at least one λ/4 retardation plate.
   [6]

The optical laminate according to [5],
in which the λ/4 retardation plate is formed by fixing a liquid crystal phase.
   [7]

An optical lens having a curved surface portion,
wherein the optical laminate according to any one of [1] to [6] is bonded to the curved surface portion.
   [8]

A virtual reality display apparatus comprising:
an image display apparatus which emits polarized light;
a half mirror having a curved surface portion; and
the optical lens according to [7].

According to the present invention, it is possible to provide an optical laminate which exhibits high image sharpness in a case of being bonded to a lens or the like of a virtual reality display apparatus. In addition, according to the present invention, it is possible to provide an optical lens and a virtual reality display apparatus.

### BRIEF DESCRIPTION OF THE DRAWINGS

FIG. 1 is an example of a virtual reality display apparatus using an optical laminate according to the embodiment of the present invention.

### DESCRIPTION OF THE PREFERRED EMBODIMENTS

Hereinafter, the present invention will be described in detail with reference to the accompanying drawings. The description of the configuration requirements described below may be made based on representative embodiments or specific examples, but the present invention is not limited to such embodiments. Any numerical range expressed using “to” in the present specification refers to a range including the numerical values before and after the “to” as a lower limit value and an upper limit value, respectively.

In the present specification, the term “orthogonal” does not denote only 90° in a strict sense, but denotes 90°±10°, preferably 90°±5°. In addition, a term “parallel” does not denote only 0° in a strict sense, but denotes 0°±10°, preferably 0°±5°. Furthermore, a term “45°” does not denote only 45° in a strict sense, but denotes 45°±10°, preferably 45°±5°.

In the present specification, a term “absorption axis” denotes a polarization direction in which absorbance is maximized in a plane in a case where linearly polarized light is incident. In addition, a term “reflection axis” denotes a polarization direction in which reflectivity is maximized in a plane in a case where linearly polarized light is incident. In addition, a term “transmission axis” denotes a direction orthogonal to the absorption axis or the reflection axis in a plane. Furthermore, a term “slow axis” denotes a direction in which refractive index is maximized in a plane.

In the present specification, “in a polarization state orthogonal to each other” refers to a polarization state located at antipodal points on a Poincare sphere, and for example, linearly polarized light orthogonal to each other corresponds to this. In addition, in general, clockwise circularly polarized light and counterclockwise circularly polarized light are not expressed as the “in a polarization state orthogonal to each other”; but in the definition of the present specification, the clockwise circularly polarized light and the counterclockwise circularly polarized light are also interpreted as being in the polarization state orthogonal to each other.

In the present specification, a retardation denotes an in-plane retardation unless otherwise specified, and is referred to as Re (λ). Here, Re (λ) represents an in-plane retardation at a wavelength λ, and the wavelength λ is 550 nm unless otherwise specified.

In addition, a retardation at the wavelength λ in a thickness direction is referred to as Rth (λ) in the present specification.

As Re (λ) and Rth (λ), values measured at the wavelength λ with AxoScan OPMF-1 (manufactured by Opto Science, Inc.) can be used. By inputting an average refractive index ((nx+ny+nz)/3) and a film thickness (d (μm)) in AxoScan, a slow axis direction (°), Re(λ)=R0(λ), and Rth(λ)=((nx+ny)/2−nz)×d are calculated.

### [Optical Laminate]

The optical laminate according to the embodiment of the present invention includes a reflective polarizer, an absorptive polarizer, and at least one adhesive layer, in which, in a case where the reflective polarizer is heated for 1 minute at a temperature higher than a glass transition temperature of the reflective polarizer by 20° C., the reflective polarizer exhibits a dimensional change of a contraction of 0% or more and less than 0.8% in at least one in-plane orientation. In addition, the reflective polarizer is a reflective linear polarizer formed by alternately laminating two or more different types of birefringent layers.

Here, a method of measuring the glass transition temperature of the reflective polarizer will be described. E″ (loss elastic modulus) and E′ (storage elastic modulus) of a film sample (reflective polarizer) which has been humidity-adjusted in advance in an atmosphere of a temperature of 25° C. and a humidity of 60% Rh for 2 hours or longer are measured under the following conditions using a dynamic viscoelasticity measuring device (DVA-200 manufactured by IT Measurement & Control Co., Ltd.), and the values are used to acquire tan δ (=E″/E′).
Device: DVA-200, manufactured by IT Measurement & Control Co., Ltd.
Sample: 5 mm, length of 50 mm (gap of 20 mm)
Measurement conditions: tension mode
Measuring temperature: −150° C. to 220° ° C.
Temperature rising condition: 5° C./min
Frequency: 1 Hz

In this case, the peak temperature of tan δ to be obtained is the glass transition temperature.

With the optical laminate according to the embodiment of the present invention, it is possible to exhibit high image sharpness in a case of being bonded to a lens or the like of a virtual reality display apparatus. As a suitable use example for the function of the optical laminate according to the embodiment of the present invention, a case where the optical laminate according to the embodiment of the present invention is used for a virtual reality display apparatus will be described in detail.

Hereinafter, in a case where the optical laminate is bonded to a lens or the like of a virtual reality display apparatus and used, the ability to exhibit high image sharpness is also referred to as “excellent image sharpness”.

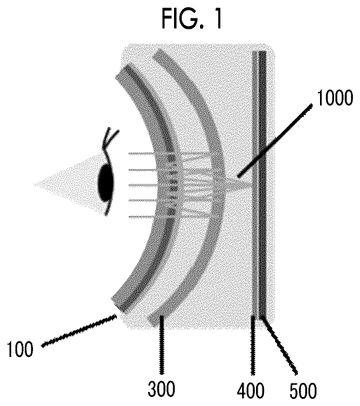

FIG. 1 is a virtual reality display apparatus using the optical laminate according to the embodiment of the present invention. As shown in FIG. 1, a ray 1000 emitted from an image display panel 500 is transmitted through a circular polarizer 400 to be converted into circularly polarized light, and is transmitted through a half mirror 300. Next, in an optical laminate 100 according to the embodiment of the present invention, the ray is incident from the reflective polarizer side, is totally reflected, is reflected again from the half mirror 300, and is incident again into the optical laminate 100. In this case, the ray 1000 is reflected by the half mirror, and thus, the ray 1000 is circularly polarized light orthogonal to the circularly polarized light incident into the optical laminate 100 for the first time. Therefore, the ray 1000 is transmitted through the optical laminate 100, and visually recognized by a user. In addition, in a case where the ray 1000 is reflected by the half mirror 300, since the half mirror has a concave mirror shape, the image is magnified so that the user can visually recognize the magnified virtual image. The system described above is referred to as a reciprocating optical system, a folded optical system, or the like.

In the virtual reality display apparatus using the optical laminate, the image is magnified and displayed by the reciprocating optical system. In this case, in a case where the optical laminate has unevenness, the ray is bent in a direction other than a predetermined direction, and thus the image sharpness is deteriorated. Therefore, in order to improve the image sharpness in a case where the optical laminate is used in a virtual reality display apparatus, it is preferable that the optical laminate has small unevenness and high smoothness.

Various sensors using near-infrared light as a light source, such as eye tracking, facial expression recognition, and iris authentication, may be incorporated into an optical system of a virtual reality display apparatus, an electronic finder, or the like. In order to minimize the influence on such a sensor, it is preferable that the optical laminate according to the embodiment of the present invention has transparency to near-infrared light.

### [Reflective Polarizer]

The optical laminate according to the embodiment of the present invention includes, as at least a reflective polarizer, a reflective linear polarizer formed by alternately laminating two or more different types of birefringent layers, in which the reflective polarizer exhibits a dimensional change of a contraction of 0% or more and less than 0.8% due to the above-described heating.

In the present specification, in a case where a dimensional change in a case of heating at a temperature higher than a glass transition temperature of the reflective polarizer by 20° C. for 1 minute is 0%, that is, in a case where a dimension of the reflective polarizer does not change due to the heating, the dimensional change is also included in the “contraction of 0% or more and less than 0.8%”.

The reflective linear polarizer is a polarizer which allows transmission of linearly polarized light in one direction and reflects linearly polarized light in a direction orthogonal to the linearly polarized light.

Examples of the reflective linear polarizer include a film obtained by stretching a dielectric multi-layer film in which two or more different types of birefringent layers are alternately laminated, as described in JP2011-053705A, M. F. Weber, C. A. Stover, L. R. Gilbert, T. J. Nevitt and A. J. Ouderkirk, Science 287 (5462), 2451-2456 (2000), and the like. In addition, as the reflective linear polarizer, a commercially available product can be suitably used. Examples of the commercially available product of the reflective linear polarizer include a reflective polarizer (trade name: APF) manufactured by 3M.

In the reflective polarizer used in the optical laminate according to the embodiment of the present invention, the dimensional change in a case where the optical laminate is heated at a temperature higher than a glass transition temperature of the reflective polarizer by 20° C. for 1 minute is a contraction of 0% or more and less than 0.8% in at least one in-plane orientation.

Here, whether the dimensional change of the reflective polarizer is contraction or expansion is confirmed by measuring the dimension of the reflective polarizer before and after the above-described heating.

In a case where the dimensional change of the reflective polarizer is contraction, that is, in a case where the dimension after the heating is smaller than the dimension before the heating, the dimensional change indicating the degree of contraction due to the heating is calculated from the measured values of the dimensions before and after the heating according to the following expression.

Dimensional change of reflective polarizer={(Dimension of reflective polarizer before heating)−(Dimension of reflective polarizer after heating)}/(Dimension of reflective polarizer before heating)×100

In a case where the optical laminate according to the embodiment of the present invention is bonded to a lens or the like of a virtual reality display apparatus and used, details of the mechanism by which high image sharpness is exhibited are not clear, but can be presumed as follows.

In a case where the optical laminate is bonded to a lens or the like, the optical laminate may be heated in order to improve the adhesion. In particular, in a case where the lens has a curved surface portion, the optical laminate is often heated to a temperature higher than the glass transition temperature of the reflective polarizer in order to form the optical laminate into a curved surface shape. In this case, in a case where the reflective polarizer expands due to the heating, the absorptive polarizer or the like bonded to the reflective polarizer may be broken, and the smoothness of the optical laminate after being bonded to the lens may be significantly impaired.

In addition, the optical laminate may be heated for the purpose of a heat resistance test or the like after being bonded to the lens or the like. In this case, in a case where the reflective polarizer expands, the smoothness of the optical laminate may be impaired.

On the other hand, it is considered that, in the reflective polarizer included in the optical laminate according to the embodiment of the present invention, since the dimensional change in a case of heating at a temperature higher than the glass transition temperature by 20° C. for 1 minute is contraction, it is possible to prevent the expansion and the breakage due to the heating treatment in a case of bonding to the lens or the like, and to maintain the smoothness of the optical laminate.

On the other hand, in a case where the contraction ration of the reflective polarizer is 0.8% or more, the dimensional change of the optical laminate is large in a case where the optical laminate is bonded to the lens or the like, so that it is difficult to bond the optical laminate in a desired shape. In addition, in a case where the heat resistance test is performed after bonding the optical laminate to the lens or the like, the optical laminate may be peeled off from the lens or the like due to a large dimensional change of the optical laminate.

On the other hand, in the reflective polarizer included in the optical laminate according to the embodiment of the present invention, since the contraction ration in a case of heating at a temperature higher than the glass transition temperature by 20° C. for 1 minute is less than 0.8%, the optical laminate can be easily bonded to the lens or the like in a desired shape, and the dimensional change of the optical laminate in the heat resistance test can be suppressed, so that the peeling of the optical laminate can be prevented.

As a result, it is presumed that, in a case where the optical laminate according to the embodiment of the present invention is bonded to the lens or the like of a virtual reality display apparatus and used, high image sharpness can be exhibited.

In the reflective polarizer included in the optical laminate according to the embodiment of the present invention, the dimensional change due to the above-described heating is preferably a contraction of more than 0% and less than 0.5%, more preferably a contraction of more than 0% and less than 0.4%, and still more preferably a contraction of more than 0% and less than 0.1% in at least one in-plane orientation.

In addition, in the reflective polarizer, a dimensional change due to the above-described heating is preferably a contraction of 0% or more and less than 0.8%, more preferably a contraction of more than 0% and less than 0.5%, still more preferably a contraction of more than 0% and less than 0.4%, and particularly preferably a contraction of more than 0% and less than 0.1% in all in-plane orientations.

The glass transition temperature of the reflective polarizer is, for example, 80° C. or higher, and from the viewpoint of excellent durability, preferably 90° C. or higher and more preferably 95° C. or higher. The upper limit value thereof is not particularly limited, but is preferably 150° C. or lower.

A method of preparing the reflective polarizer included in the optical laminate is not particularly limited, and for example, a reflective polarizer in which the dimensional change due to the above-described heating is a contraction of 0% or more and less than 0.8% can be manufactured by performing a pre-heating treatment of heating a reflective polarizer to be contracted before bonding the reflective polarizer to the absorptive polarizer, the reflective polarizer being a known reflective linear polarizer or a commercially available reflective linear polarizer, in which contraction of 0.8% or more occurs in a case of heating at a temperature higher than the glass transition temperature by 20° C. for 1 minute.

In addition, in the known manufacturing process of the reflective linear polarizer, a reflective polarizer in which the dimensional change due to the above-described heating is a contraction of 0% or more and less than 0.8% can be manufactured by adjusting a stretching ratio in a case of stretching the dielectric multi-layer film.

The conditions of the above-described pre-heating treatment are not particularly limited, and may be appropriately adjusted depending on the reflective polarizer to be used. A heating temperature of the pre-heating treatment is preferably a temperature higher than the glass transition temperature of the reflective polarizer by 10° C. to 50° C. A treatment time of the pre-heating treatment is preferably 1 to 10 minutes. In addition, the pre-heating treatment can be performed using a known heating unit such as an oven.

In addition, instead of the reflective linear polarizer included in the optical laminate according to the embodiment of the present invention, an optical laminate including a reflective polarizer other than the reflective linear polarizer (hereinafter, also referred to as “other reflective polarizer”) formed by alternately laminating two or more different types of birefringent layers, in which a dimensional change in a case of heating at a temperature higher than the glass transition temperature of the reflective polarizer by 20° C. for 1 minute is a contraction of 0% or more and less than 0.8% in at least one in-plane orientation, also exhibits excellent image sharpness.

Examples of the other reflective polarizer include a wire grid type polarizer described in JP2015-028656A. As the wire grid type polarizer, a commercially available product can be suitably used. Examples of the commercially available product of the wire grid type polarizer include a wire grid type polarizer (trade name: WGF) manufactured by AGC Inc.

Another example of the other reflective polarizer is a reflective circular polarizer.

The reflective circular polarizer is a polarizer which allows transmission of dextrorotatory circularly polarized light or levorotatory circularly polarized light and reflects circularly polarized light having a turning direction opposite to that of the transmitted circularly polarized light.

Examples of the reflective circular polarizer include a reflective circular polarizer having a cholesteric liquid crystal layer. The cholesteric liquid crystal layer is a liquid crystal layer obtained by fixing a cholesterically aligned liquid crystal phase (cholesteric liquid crystalline phase).

As is well known, the cholesteric liquid crystal layer has a helical structure in which the liquid crystal compound is helically turned and laminated. In the helical structure, a configuration in which the liquid crystal compound is helically rotated once (rotated by 360°) and laminated is set as one pitch (helical pitch), and the helically turned liquid crystal compounds are laminated a plurality of pitches.

The cholesteric liquid crystal layer reflects levorotatory circularly polarized light or dextrorotatory circularly polarized light in a specific wavelength range and allows the transmission of the other light depending on the length of the helical pitch and the helical turning direction (sense) of the liquid crystal compound.

Therefore, in order to reflect the entire wavelength range over the visible region, the reflective circular polarizer may include, for example, a plurality of cholesteric liquid crystal layers including a cholesteric liquid crystal layer that has a central wavelength of selective reflection for red light, a cholesteric liquid crystal layer that has a central wavelength of selective reflection for green light, and a cholesteric liquid crystal layer that has a central wavelength of selective reflection for blue light.

In the other reflective polarizer, the dimensional change in a case of heating at a temperature higher than a glass transition temperature of the reflective polarizer by 20° C. for 1 minute is a contraction of 0% or more and less than 0.8% in at least one in-plane orientation. The dimensional change, the manufacturing method, and the like of the other reflective polarizer may be the same as those of the reflective linear polarizer in which the two or more types of birefringent layers are alternately laminated, including the preferred ranges thereof.

### [Absorptive Polarizer]

The optical laminate according to the embodiment of the present invention includes at least an absorptive polarizer.

The absorptive polarizer used in the optical laminate according to the embodiment of the present invention absorbs linearly polarized light in an absorption axis direction in the incidence ray and allows transmission of linearly polarized light in a transmission axis direction.

A single plate transmittance of the absorptive polarizer is preferably 40% or more, and more preferably 42% or more. Moreover, a degree of polarization is preferably 90% or more, more preferably 95% or more, and still more preferably 99% or more. In the present invention, the single plate transmittance and the degree of polarization of the absorptive polarizer are measured using an automatic polarizing film measuring device: VAP-7070 (manufactured by Jasco Corporation).

In the optical laminate, it is preferable that the absorptive polarizer is disposed such that an orientation of an absorption axis of the absorptive polarizer is parallel to an orientation of a reflection axis of the reflective polarizer.

The absorptive polarizer used in the optical laminate according to the embodiment of the present invention preferably includes an anisotropic absorption layer containing at least a liquid crystal compound and a dichroic coloring agent. This is because the thickness of the anisotropic absorption layer containing a liquid crystal compound and a dichroic coloring agent can be reduced, and cracks or breakage are less likely to occur even in a case where the anisotropic absorption layer is stretched or formed.

The thickness of the anisotropic absorption layer is not particularly limited, but from the viewpoint of thinning, it is preferably 0.1 to 8 μm and more preferably 0.3 to 5 μm.

The absorptive polarizer containing a liquid crystal compound and a dichroic coloring agent can be produced with reference to, for example, JP2020-023153A. From the viewpoint of improving the degree of polarization of the absorptive polarizer, an alignment degree of the dichroic coloring agent in the anisotropic absorption layer is preferably 0.95 or more, and more preferably 0.97 or more.

The absorptive polarizer may include a layer other than the anisotropic absorption layer, such as a support, an alignment layer, and a protective layer.

The alignment layer is used for aligning the liquid crystal compound contained in the anisotropic absorption layer in a specific orientation. The alignment layer is not particularly limited, and a layer obtained by rubbing a layer containing polyvinyl alcohol or a photo-alignment film can be used.

The protective layer can be provided by being applied onto the anisotropic absorption layer. A formulation of the protective layer is not particularly limited, but from the viewpoint of improving the durability of the anisotropic absorption layer, a layer containing polyvinyl alcohol is preferable.

The type of the support is not particularly limited, but it is preferable that the support is transparent, and examples thereof include films made of cellulose acylate, polycarbonate, polysulfone, polyethersulfone, polyacrylate and polymethacrylate, cyclic polyolefin, polyolefin, polyamide, polystyrene, polyester, or the like. Among these, a cellulose acylate film, a cyclic polyolefin film, polyacrylate, a polyacrylate film, or a polymethacrylate film is preferable. In addition, commercially available cellulose acylate films (for example, “TD80U” and “Z-TAC” manufactured by FUJIFILM Corporation) can also be used.

In addition, from the viewpoint of suppressing the adverse effect on the degree of polarization of transmitted light and reflected light, it is preferable that the support has small phase difference. Specifically, a magnitude of Re is preferably 10 nm or less, and an absolute value of a magnitude of Rth is preferably 50 nm or less.

In addition, the absorptive polarizer may be formed by supplying a transfer film in which a layer including an anisotropic absorption layer is applied onto a temporary support, transferring the anisotropic absorption layer to produce another laminate, and then peeling and removing the temporary support. By removing the temporary support, the optical laminate can be thinned, and the adverse effect of the phase difference of the temporary support on the degree of polarization of the transmitted light and the reflected light can be removed.

From the viewpoint of preventing breakage during peeling, the temporary support is preferably a support having a high tear strength. As the temporary support, a polycarbonate-based film or a polyester-based film is preferable. In addition, in the manufacturing step of the optical laminate, it is preferable that the temporary support has small phase difference in order to perform quality inspection of the anisotropic absorption layer and the other laminate.

In addition, in a case where the absorptive polarizer is supplied as a transfer film in which a layer including an anisotropic absorption layer is applied onto a temporary support, it is preferable that the absorptive polarizer is supplied in a form in which a protective film is laminated in order to prevent the layer including an anisotropic absorption layer from being peeled off and becoming a foreign matter in a slit step or the like during the transport of the film or before bonding.

### [Adhesive Layer]

The optical laminate according to the embodiment of the present invention includes at least one adhesive layer.

The optical laminate according to the embodiment of the present invention is a laminate including a plurality of functional layers including the reflective polarizer and the absorptive polarizer. It is preferable that the respective functional layers of the optical laminate are bonded to each other through the adhesive layer. The adhesive layer can be formed using, for example, an adhesive or a pressure sensitive adhesive.

As the adhesive, a commercially available adhesive or the like can be optionally used. As a more specific adhesive, an epoxy resin-based adhesive and an acrylic resin-based adhesive can be used.

As the pressure sensitive adhesive, a commercially available pressure sensitive adhesive can be optionally used, and a pressure sensitive adhesive which is unlikely to generate outgas is preferable. In particular, in a case where the optical laminate is stretched or formed, a vacuum process or a heating process may be performed. It is preferable that the outgas is not generated from the adhesive layer even under the conditions of the vacuum process or heating process.

From the viewpoint of improving the smoothness of the optical laminate and improving the sharpness of the image of the virtual reality display apparatus or the like using the optical laminate, a thickness of the adhesive layer is preferably 15 μm or less, more preferably 10 μm or less, and still more preferably 6 μm or less.

In addition, the lower limit of the thickness of the adhesive layer is not particularly limited, but from the viewpoint of burying and smoothing out foreign matter present inside the optical laminate, it is preferably 0.5 μm or more, and more preferably 1 μm or more.

### <Adhesive>

The adhesive layer can be formed, for example, by irradiating a composition for forming an adhesive layer, containing an ultraviolet curable adhesive, with ultraviolet rays to cure the composition. It is preferable that at least one of the adhesive layers included in the optical laminate is a layer formed by curing a composition for forming an adhesive layer, which contains an ultraviolet curable adhesive.

As the ultraviolet curable adhesive, a known adhesive can be used. The type of the composition for forming an adhesive layer is not particularly limited, but from the viewpoint of improving adhesive force to the functional layer, it is preferable that the composition for forming an adhesive layer contains a compound containing a (meth)acryloyl group, and it is also preferable that the composition for forming an adhesive layer contains a boronic acid compound.

From the viewpoint of making the coating thickness uniform, a viscosity of the composition for forming an adhesive layer is preferably 10 cP or more and 500 cP or less, more preferably 50 cP or more and 400 cP or less, and still more preferably 100 cP or more and 350 cP or less.

In addition, the adhesive layer can also be formed by bonding a sheet containing a composition for forming an adhesive layer, which contains an ultraviolet curable adhesive, to one adherend, bonding the other adherend to the sheet, and then irradiating the sheet with ultraviolet rays to cure the adhesive layer.

In a case where the adherend is irradiated with ultraviolet rays after the bonding, the adhesive force of the adhesive layer can be further improved. In addition, in a case where the optical laminate is stretched or formed, the outgas in the vacuum process or the heating process can be suppressed.

### <Pressure Sensitive Adhesive>

The adhesive layer can also be formed by bonding a pressure sensitive adhesive sheet.

It is preferable that at least one of the adhesive layers included in the optical laminate is a layer consisting of a pressure sensitive adhesive sheet.

The type of the pressure sensitive adhesive sheet is not limited, but from the viewpoint of improving the smoothness of the optical laminate, a storage elastic modulus G′ measured by a torsional shear method at 20° C. is preferably 0.8 MPa or more, more preferably 1.5 MPa or more, and still more preferably 2.0 MPa or more. The upper limit value thereof is not particularly limited, but is preferably 30 MPa or less.

The storage elastic modulus G′ of the pressure sensitive adhesive sheet, measured by the torsional shear method, can be measured, for example, using a viscoelasticity measuring device such as “HAAKE MARS” manufactured by Thermo Fisher Scientific. In a case where a commercially available pressure sensitive adhesive sheet is used, the above-described storage elastic modulus G′ may be a catalog value.

### [λ/4 Retardation Plate]

The optical laminate according to the embodiment of the present invention may further include at least one λ/4 retardation plate.

In the present specification, the Δ/4 retardation plate refers to a retardation plate having an in-plane retardation (Re) of approximately 1/4 wavelength at any wavelength of visible light.

The λ/4 retardation plate has an action of converting circularly polarized light into linearly polarized light and converting linearly polarized light into circularly polarized light. Therefore, by laminating the λ/4 retardation plate and the absorptive polarizer such that an orientation of a slow axis of the λ/4 retardation plate forms an angle of 45° with an orientation of an absorption axis of the absorptive polarizer, an optical laminate which can be used as an absorptive circular polarization plate is obtained.

In addition, by laminating the λ/4 retardation plate and the reflective linear polarizer such that an orientation of a slow axis of the λ/4 retardation plate forms an angle of 45° with an orientation of a transmission axis of the reflective linear polarizer, an optical laminate which can be used as a reflective circular polarization plate is obtained.

Furthermore, an optical laminate which can be used as a reflective linear polarizer can be obtained by laminating the λ/4 retardation plate and the reflective circular polarizer at any angle.

As the λ/4 retardation plate, a λ/4 retardation plate having a Re of 120 to 150 nm at a wavelength of 550 nm is preferable, a λ/4 retardation plate having a Re of 130 to 150 nm is more preferable, and a λ/4 retardation plate having a Re of 130 to 140 nm is still more preferable.

In addition, since a retardation plate in which Re is approximately 3/4 wavelength or approximately 5/4 wavelength can also convert linearly polarized light into circularly polarized light, the retardation plate can be used in the same manner as the λ/4 retardation plate.

In addition, it is preferable that the λ/4 retardation plate has reverse dispersibility with respect to the wavelength. This is because the λ/4 retardation plate has reverse dispersibility from the viewpoint that circularly polarized light can be converted into linearly polarized light over a wide wavelength range in the visible region. Here, the expression “having reverse dispersibility with respect to the wavelength” denotes that as the wavelength increases, the value of the phase difference at the wavelength increases.

The retardation plate having reverse dispersibility can be produced, for example, by uniaxially stretching a polymer film such as a modified polycarbonate resin film having reverse dispersibility with reference to JP2017-049574A and the like.

In addition, the retardation plate having reverse dispersibility is not limited as long as the retardation plate substantially has reverse dispersibility, and can be prepared by laminating a retardation plate having Re of an approximately 1/4 wavelength and a retardation plate having Re of an approximately 1/2 wavelength such that the slow axes form an angle of approximately 60° as described in, for example, JP6259925B. Here, it is known that even in a case where the 1/4 wavelength retardation plate and the 1/2 wavelength retardation plate each have forward dispersibility (as the wavelength increases, the value of the phase difference at the wavelength decreases), circularly polarized light can be converted into linearly polarized light over a wide wavelength range in the visible region, and the layers can be regarded as having substantially reverse dispersibility. In this case, the optical laminate preferably includes a reflective circular polarizer, a 1/4 wavelength retardation plate, a 1/2 wavelength retardation plate, and a linear polarizer in this order.

In addition, it is also preferable that the optical laminate includes, as the retardation plate, a layer formed by immobilizing uniformly aligned liquid crystal compounds. For example, a layer formed by uniformly aligning rod-like liquid crystal compounds horizontally to the in-plane direction and a layer formed by uniformly aligning disk-like liquid crystal compounds vertically to the in-plane direction can be used. Furthermore, for example, a retardation plate having reverse dispersibility can be prepared by uniformly aligning rod-like liquid crystal compounds having reverse dispersibility and immobilizing the compounds with reference to JP2020-084070A and the like.

In addition, it is also preferable that the optical laminate includes, as the retardation plate, a layer formed by immobilizing twistedly aligned liquid crystal compounds with a helical axis in the thickness direction. For example, as described in JP5753922B and JP5960743B, it is preferable that a retardation plate having a layer formed by immobilizing twistedly aligned rod-like liquid crystal compounds or twistedly aligned disk-like liquid crystal compounds with a helical axis in the thickness direction is used from the viewpoint that the retardation plate can be regarded as having substantially reverse dispersibility.

A thickness of the λ/4 retardation plate is not particularly limited, but from the viewpoint of thinning, it is preferably 0.1 to 8 μm and more preferably 0.3 to 5 μm. In addition, from the viewpoint of thinning, a λ/4 retardation plate in which a liquid crystal phase is fixed is preferable.

The λ/4 retardation plate may include a support, an alignment layer, a retardation plate, and the like.

The type of the support is not particularly limited, but it is preferable that the support is transparent, and examples thereof include films made of cellulose acylate, polycarbonate, polysulfone, polyethersulfone, polyacrylate and polymethacrylate, cyclic polyolefin, polyolefin, polyamide, polystyrene, polyester, or the like. Among these, a cellulose acylate film, a cyclic polyolefin film, polyacrylate, a polyacrylate film, or a polymethacrylate film is preferable. In addition, commercially available cellulose acylate films (for example, “TD80U” and “Z-TAC” manufactured by FUJIFILM Corporation) can also be used.

In addition, from the viewpoint of suppressing the adverse effect on the degree of polarization of transmitted light and reflected light, it is preferable that the support has small phase difference. Specifically, a magnitude of Re is preferably 10 nm or less, and an absolute value of a magnitude of Rth is preferably 50 nm or less.

In addition, the λ/4 retardation plate may be formed by supplying a transfer film in which a layer including a retardation layer is applied onto a temporary support, transferring the retardation layer to another laminate, and then peeling and removing the temporary support. By removing the temporary support, the optical laminate can be thinned, and the adverse effect of the phase difference of the temporary support on the degree of polarization of the transmitted light and the reflected light can be removed, which is preferable.

From the viewpoint of preventing breakage during peeling, the temporary support is preferably a support having a high tear strength. As the temporary support, a polycarbonate-based film or a polyester-based film is preferable. In addition, in the manufacturing step of the optical laminate, it is preferable that the temporary support has small phase difference in order to perform quality inspection of the anisotropic absorption layer and the other laminate.

### [Other Functional Layers]

The optical laminate may include other functional layers.

### <Positive C-Plate>

It is also preferable that the optical laminate further includes a positive C-plate. Here, the positive C-plate is a retardation layer in which the Re is substantially zero and the Rth has a negative value. The positive C-plate can be obtained, for example, by vertically aligning rod-like liquid crystal compounds. With regard to the details of the method for manufacturing the positive C-plate, reference can be made to the description in, for example, JP2017-187732A, JP2016-053709A, and JP2015-200861A.

The positive C-plate functions as an optical compensation layer for increasing the degree of polarization of the transmitted light and the reflected light with respect to light incident obliquely. The positive C-plate can be installed at any place of the optical laminate, and a plurality of positive C-plates may be installed.

The positive C-plate may be disposed adjacent to the reflective circular polarizer or inside the reflective circular polarizer. For example, in a case where a light reflecting layer containing a rod-like liquid crystal compound, which is formed by fixing a cholesteric liquid crystalline phase, is used as the reflective circular polarizer, the light reflecting layer has a positive Rth. Here, in a case where light is incident on the reflective circular polarizer in an oblique direction, the polarization states of the reflected light and the transmitted light may change due to the action of the Rth, and the degree of polarization of the reflected light and the transmitted light may decrease. In a case where the positive C-plate is provided inside the reflective circular polarizer and/or in the vicinity thereof, the change in polarization state of the oblique incident light is suppressed and the decrease in degree of polarization of the reflected light and the transmitted light can be suppressed, which is preferable.

In addition, the positive C-plate may be provided adjacent to the λ/4 retardation plate or inside the λ/4 retardation plate. For example, in a case where a layer formed by immobilizing rod-like liquid crystal compounds is used as the λ/4 retardation plate, the λ/4 retardation plate has a positive Rth. Here, in a case where light is incident on the λ/4 retardation plate in an oblique direction, the polarization state of the transmitted light may change due to the action of the Rth, and the degree of polarization of the transmitted light may decrease. In a case where the positive C-plate is provided inside the λ/4 retardation plate and/or in the vicinity thereof, the change in polarization state of the oblique incident light is suppressed and the decrease in degree of polarization of the transmitted light can be suppressed, which is preferable. It is preferable that the positive C-plate is disposed on a surface of the λ/4 retardation plate on a side opposite to the absorptive polarizer, but the positive C-plate may be disposed at another place. Re of the positive C-plate in this case is preferably approximately 10 nm or less, and Rth thereof is preferably −90 to −40 nm.

### <Antireflection Layer>

It is also preferable that the optical laminate includes an antireflection layer on a surface thereof. The optical laminate according to the embodiment of the present invention has a function of reflecting specific polarized light and transmitting polarized light orthogonal to the specific polarized light, and the reflection on a surface of the optical laminate typically includes unintended reflection of polarized light, which leads to the decrease in degree of polarization of the transmitted light and the reflected light. Therefore, it is preferable that the optical laminate includes an antireflection layer on the surface thereof. The antireflection layer may be provided only on one surface or on both surfaces of the optical laminate.

The type of the antireflection layer is not particularly limited, but from the viewpoint of further decreasing the reflectivity, a moth-eye film or an AR film is preferable. In addition, in a case where the optical laminate is stretched or formed, the moth-eye film is preferable from the viewpoint that high antireflection performance can be maintained even in a case of fluctuation in the film thickness due to the stretching. Furthermore, in a case where the antireflection layer includes a support and stretching or forming is performed, from the viewpoint of facilitating the stretching or the forming, the above-described support has a Tg peak temperature of preferably 170° C. or lower and more preferably 130° C. or lower. Specifically, a PMMA film or the like is preferable.

### <Second λ/4 Retardation Plate>

It is also preferable that the optical laminate further includes a second λ/4 retardation plate. The optical laminate may include, for example, a reflective circular polarizer, a λ/4 retardation plate, an absorptive polarizer, and a second λ/4 retardation plate in this order.

Light which is incident into the optical laminate from the reflective polarizer side and is transmitted through the absorptive polarizer is linearly polarized light, and a part of the light is reflected from the outermost surface of the absorptive polarizer and is emitted from the surface of the reflective polarizer again. Such light is extra reflected light and may decrease the degree of polarization of the reflected light, and thus it is preferable that the amount of such light is reduced. A method of laminating the antireflection layer may be used as a method for suppressing reflection on the outermost surface on the absorptive polarizer side, but in a case where the optical laminate is used by being bonded to a medium such as glass and plastic, the antireflection effect cannot be obtained because reflection on the surface of the medium cannot be suppressed even in a case where the antireflection layer is provided on the bonding surface of the optical laminate.

Meanwhile, in a case where the second λ/4 retardation plate which converts linearly polarized light into circularly polarized light is provided, light which reaches the outermost surface on the absorptive polarizer side is converted into circularly polarized light, and converted into circularly polarized light orthogonal to each other in a case of reflection on the outermost surface of the medium. Thereafter, in a case where the light transmits through the second λ/4 retardation plate again and reaches the absorptive polarizer, the light is linearly polarized light in the absorption axis orientation of the absorptive polarizer and is absorbed. Therefore, it is possible to prevent extra reflection.

From the viewpoint of more effectively suppressing the extra reflection, it is preferable that the second λ/4 retardation plate has substantially reverse dispersibility.

### <Support>

The optical laminate according to the embodiment of the present invention may further include a support. The support can be disposed at any place.

The type of the support is not particularly limited, but it is preferable that the support is transparent. Examples thereof include films made of cellulose acylate, polycarbonate, polysulfone, polyethersulfone, polyacrylate and polymethacrylate, cyclic polyolefin, polyolefin, polyamide, polystyrene, polyester, or the like. Among these, a cellulose acylate film, a cyclic polyolefin film, polyacrylate, a polyacrylate film, or a polymethacrylate film is preferable. In addition, commercially available cellulose acylate films (for example, “TD80U” and “Z-TAC” manufactured by FUJIFILM Corporation) can also be used.

In addition, it is preferable that the support has small phase difference from the viewpoint of suppressing the adverse effect on the degree of polarization of the transmitted light and the reflected light and viewpoint of facilitating the optical inspection of the optical laminate. Specifically, a magnitude of Re is preferably 10 nm or less, and an absolute value of a magnitude of Rth is preferably 50 nm or less.

In a case where a method for manufacturing the optical laminate according to the embodiment of the present invention includes a step of stretching or forming, from the viewpoint of enabling forming at a low temperature, a glass transition temperature (peak temperature of tan δ) of the support is preferably 120° C. or lower.

The support having a glass transition temperature of 120° C. or lower is not particularly limited, and various resin base materials can be used. As the resin base material, from the viewpoint of being easily available on the market and excellent transparency, a base material consisting of a cyclic olefin-based resin or a base material consisting of polymethacrylic acid ester is preferable.

Examples of the commercially available resin base material include TECHNOLLOY (registered trademark) S001G, TECHNOLLOY S014G, TECHNOLLOY S000, TECHNOLLOY C001, and TECHNOLLOY C000 (Sumika Acryl Co., Ltd.), ZEONOR FILM (Zcon Corporation), and Arton Film (JSR Corporation).

A thickness of the support is not particularly limited, and is preferably 5 to 300 μm, more preferably 5 to 100 μm, and still more preferably 5 to 30 μm.

### [Method for Manufacturing Optical Laminate]

The adhesion or the bonding of the layers may be carried out by roll-to-roll or single-wafer.

The roll-to-roll method is preferable from the viewpoint of improving the productivity and reducing axis misalignment of each layer.

On the other hand, the single-wafer method is preferable from the viewpoint that it is suitable for the production of a small amount of various kinds.

Examples of the method of applying the adhesive onto the adherend include known methods such as a roll coating method, a gravure printing method, a spin coating method, a wire bar coating method, an extrusion coating method, a direct gravure coating method, a reverse gravure coating method, a die-coating method, a spraying method, and an ink jet method.

### [Application of Optical Laminate]

The optical laminate according to the embodiment of the present invention can be used by being incorporated into, for example, an image display apparatus such as an in-vehicle room mirror, a virtual reality display apparatus, an electronic viewfinder, and an aerial image display apparatus. In particular, in the virtual reality display apparatus, the electronic viewfinder, or the like having a reciprocating optical system, the optical laminate according to the embodiment of the present invention is very useful from the viewpoint of suppressing ghosts and improving the sharpness of a display image.

The optical laminate according to the embodiment of the present invention is preferably used by being bonded to an optical lens, and among these, it is more preferable to be used by being bonded to an optical lens having a curved surface portion. The optical laminate according to the embodiment of the present invention can be bonded to any of a curved surface portion or a plane portion of an optical lens and used; but from the viewpoint that the image sharpness is more excellent, it is preferable that the optical laminate according to the embodiment of the present invention is bonded to a curved surface portion of an optical lens having a curved surface portion.

It is preferable that the virtual reality display apparatus includes an image display device, a half mirror, and an optical lens to which the optical laminate according to the embodiment of the present invention is bonded.

The optical lens is preferably an optical lens having a curved surface portion, and more preferably an optical lens in which the optical laminate according to the embodiment of the present invention is bonded to the curved surface portion.

The image display device is preferably an image display device which emits polarized light.

The half mirror is preferably a half mirror having a curved surface portion.

### EXAMPLES

Hereinafter, the features of the present invention will be described in more detail with reference to Examples. The materials, the used amounts, the proportions, the treatment contents, the treatment procedures, and the like described in Examples can be appropriately changed without departing from the gist of the present invention. In addition, configurations other than the configurations described below can be employed without departing from the gist of the present invention.

### [Production of Absorptive Polarizer 1]

### [Production of Transparent Support]

### <Production of Core Layer Cellulose Acylate Dope>

The following components were put into a mixing tank and stirred to dissolve each component, thereby preparing a cellulose acetate solution used as a core layer cellulose acylate dope.

Core layer cellulose acylate dope

| | |
|---|---|
| Cellulose acetate having acetyl substitution degree of 2.88 | 100 parts by mass |
| Polyester compound B described in Examples of JP2015-227955A | 12 parts by mass |
| Compound F shown below | 2 parts by mass |
| Methylene chloride (first solvent) | 430 parts by mass |
| Methanol (second solvent) | 64 parts by mass |

Compound F

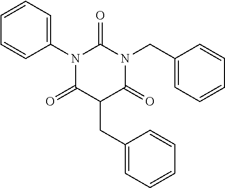 [SMILES: O=C1C(Cc2ccccc2)C(=O)N(c2ccccc2)C(=O)N1Cc1ccccc1]

### <Production of Outer Layer Cellulose Acylate Dope>

10 parts by mass of the following matting agent solution was added to 90 parts by mass of the above-described core layer cellulose acylate dope to prepare a cellulose acetate solution used as an outer layer cellulose acylate dope.

Matting agent solution

| | | |
|---|---|---|
| Silica particles having an average particle diameter | 2 | parts by mass |
| of 20 nm (AEROSIL R972, manufactured by | | |
| Nippon Aerosil Co., Ltd.) | | |
| Methylene chloride (first solvent) | 76 | parts by mass |
| Methanol (second solvent) | 11 | parts by mass |
| Core layer cellulose acylate dope described above | 1 | part by mass |

### <Production of Cellulose Acylate Film 1>

The above-described core layer cellulose acylate dope and the above-described outer layer cellulose acylate dope were filtered through a filter paper having an average hole diameter of 34 μm and a sintered metal filter having an average hole diameter of 10 μm. Thereafter, using a band casting machine, the core layer cellulose acylate dope and the outer layer cellulose acylate dopes on both sides thereof were cast simultaneously on a drum at 20° C. from a casting port in three layers.

Next, the film was peeled off in a state where the solvent content was approximately 20% by mass, both ends of the film in the width direction were fixed by tenter clips, and the film was dried while being stretched at a stretching ratio of 1.1 times in the lateral direction.

Thereafter, the film was further dried by being transported between the rolls of the heat treatment device to produce an optical film (transparent support) having a thickness of 40 μm. The optical film was used as a cellulose acylate film 1.

### [Formation of Photo-Alignment Film PA1]

The above-described cellulose acylate film 1 (support) was continuously coated with the following coating liquid PA1 for forming a photo-alignment film using a wire bar. The support on which the coating film was formed was dried with hot air at 140° C. for 120 seconds. Next, the coating film was irradiated with polarized ultraviolet rays (10 mJ/cm², using an ultra-high pressure mercury lamp) to form a photo-alignment film PA1, thereby obtaining a triacetyl cellulose (TAC) film with a photo-alignment film. A film thickness of the photo-alignment film PA1 was 1.5 μm.

Coating liquid PA1 for forming photo-alignment film

| | |
|---|---|
| Polymer PA-1 shown below | 100.00 parts by mass |
| EPICLON N-695 (manufactured by DIC Corporation) | 55.74 parts by mass |
| jER YX7400 (manufactured by Mitsubishi Chemical Corporation) | 18.75 parts by mass |
| Polymerizable polymer PA-2 shown below | 8.01 parts by mass |
| Thermal cationic polymerization initiator PAG-1 shown below | 16.75 parts by mass |
| Stabilizer DIPEA shown below | 1.06 parts by mass |
| Butyl acetate | 1230.49 parts by mass |

[Polymer PA-1
[][] 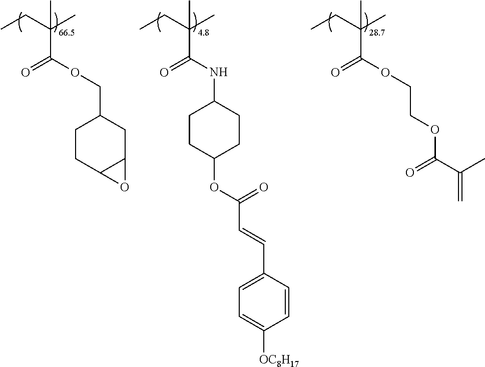 Polymerizable polymer PA-2
[in the formula, numerical values of a, b, and c represent the content (% by mass) of each repeating unit with respect to all the repeating units); weight-average molecular weight: 18,000] 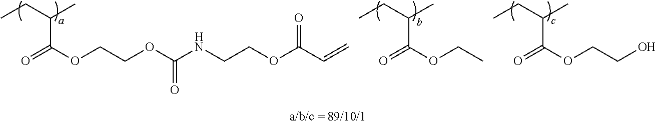
Thermal cationic polymerization initiator PAG-1 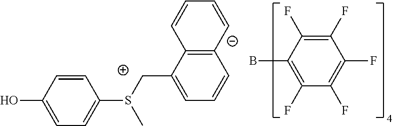
Stabilizer DIPEA

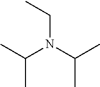

### [Production of Light Absorption Anisotropic Film P1]

A coating layer P1 was formed by continuously coating the obtained photo-alignment film PA1 with a composition P1 for forming a light absorption anisotropic film, having the following formulation, using a #20 wire bar.

Next, the coating layer P1 was heated at 140° C. for 15 seconds, and the coating layer P1 was cooled to room temperature (23° C.).

Next, the coating layer P1 was heated at 75° C. for 15 seconds, and then cooled to room temperature again.

Next, the coating layer P1 was irradiated with ultraviolet light using an LED lamp (central wavelength: 365 nm) for 2 seconds under an irradiation condition of an illuminance of 200 mW/cm², thereby producing a light absorption anisotropic film P1 (corresponding to an anisotropic absorption layer) on the photo-alignment film PA1. In a case where a transmittance of the light absorption anisotropic film in a wavelength range of 280 to 780 nm was measured with a spectrophotometer, and the average transmittance of visible light was 43%.

Formulation of composition P1 for forming light absorption anisotropic film

| | |
|---|---|
| Dichroic coloring agent Dye-Y1 shown below | 0.018 parts by mass |
| Dichroic coloring agent Dye-M1 shown below | 0.11 parts by mass |
| Dichroic coloring agent Dye-C1 shown below | 0.11 parts by mass |
| Dichroic coloring agent Dye-C2 shown below | 0.34 parts by mass |
| Liquid crystal compound L-1 shown below | 1.33 parts by mass |
| Liquid crystal compound L-3 shown below | 0.57 parts by mass |
| Adhesion improver A-1 shown below | 0.04 parts by mass |
| Polymerization initiator IRGACURE OXE-02 (manufactured by BASF) | 0.07 parts by mass |
| Surfactant F-2 shown below | 0.006 parts by mass |
| Cyclopentanone | 94.96 parts by mass |
| Benzyl alcohol | 2.43 parts by mass |

[]Dichroic coloring agent Dye-Y1
[] 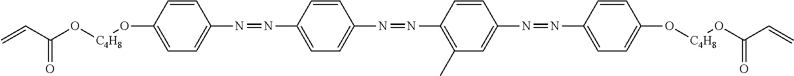 Dichroic coloring agent Dye-M1
[][] 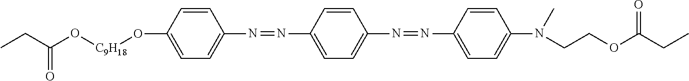 Dichroic coloring agent Dye-C1
[][] 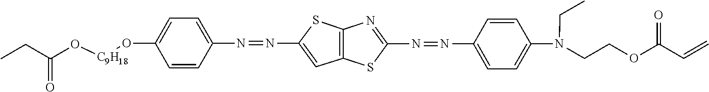 Dichroic coloring agent Dye-C2 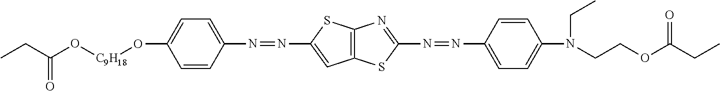
Liquid crystal compound L-1
[in the formula, the numerical values (″59″, ″15″, and ″26″) described in each repeating unit denote the content (% by mass) of each repeating unit with respect to all repeating units; weight-average molecular weight: 18,000] 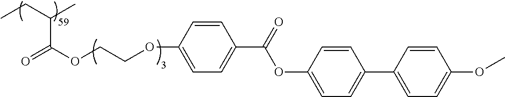 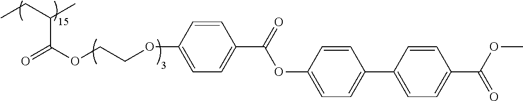 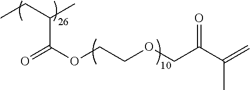
Liquid crystal compound L-3 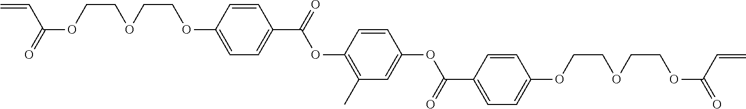 [SMILES: C=CC(=O)OCCOCCOc1ccc(C(=O)Oc2ccc(OC(=O)c3ccc(OCCOCCOC(=O)C=C)cc3)c(C)c2)cc1]
Surfactant F-2
(in the formula, the numerical value described in each repeating unit denotes the content (% by mass) of each repeating unit with respect to all repeating units; Ac represents —C(O)CH₃; and weight-average molecular weight: 15,000) 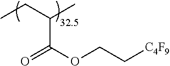 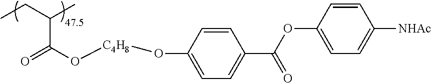 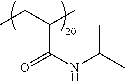
Adhesion improver A-1 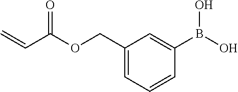
[Formation of barrier layer B1]

The light absorption anisotropic film P1 was continuously coated with a coating liquid B1 having the following formulation using a wire bar. Thereafter, the film was dried with hot air at 80° C. for 5 minutes, thereby obtaining a laminate X1 on which a barrier layer B1 consisting of polyvinyl alcohol (PVA) with a thickness of 1.0 μm was formed, that is, an absorptive polarizer 1 in which the cellulose acylate film 1 (transparent support), the photo-alignment film PA1, the light absorption anisotropic film P1, and the barrier layer B1 were provided adjacent to each other in this order.

Formulation of coating liquid B1 for forming barrier layer

| | |
|---|---|
| Modified polyvinyl alcohol shown below | 3.80 parts by mass |
| Initiator Irg2959 | 0.20 parts by mass |
| Water | 70 parts by mass |
| Methanol | 30 parts by mass |

[]Modified polyvinyl alcohol
[]

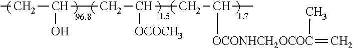

### [Production of λ/4 Retardation Plate 1]

With reference to a method described in paragraphs 0151 to 0163 of JP2020-084070A, a λ/4 retardation plate 1 having reverse wavelength dispersibility, in which a cellulose acylate film was provided as a temporary support and a liquid crystal phase was fixed, was produced.

Each retardation of the obtained λ/4 retardation plate 1 was Re=142 nm and Rth=71 nm.

### [Production of Reflective Circular Polarizer 1]

### [Production of Coating Liquids R-1 and R-4 for Reflective Layer]

A composition shown below was stirred and dissolved in a container kept at 70° C. to prepare each of coating liquids R-1 and R-4 for a reflective layer. Here, R represents a coating liquid containing a rod-like liquid crystal compound.

Coating liquids R-1 and R-4 for reflective layer

| Methyl ethyl ketone | 120.9 | parts by mass |
|---|---|---|
| Cyclohexanone | 21.3 | parts by mass |
| Mixture of rod-like liquid crystal compounds | 100.0 | parts by mass |
| shown below | | |
| Photopolymerization initiator C | 1.00 | part by mass |
| Chiral agent A shown below | shown in Table 1 | |
| Surfactant F-3 shown below | 0.027 | parts by mass |
| Surfactant F-4 shown below | 0.067 | parts by mass |

TABLE 1
Amount of chiral agent in coating liquid containing rod-like liquid crystal compound

| Coating liquid name | Type of chiral agent | Amount of chiral agent(part by mass) |
|---|---|---|
| Liquid R-1 | Chiral agent A | 3.51 |
| Liquid R-4 | Chiral agent A | 2.90 |

Mixture of rod-like liquid crystal compounds

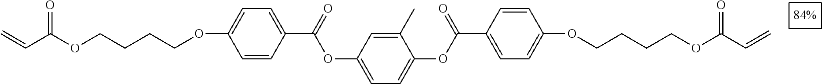 [SMILES: C=CC(=O)OCCCCOc1ccc(C(=O)Oc2ccc(OC(=O)c3ccc(OCCCCOC(=O)C=C)cc3)c(C)c2)cc1]

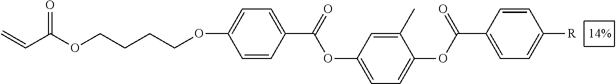

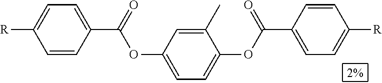

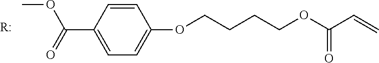

In the above-described mixture, each numerical value denotes the content in units of % by mass. In addition, R is a group bonded through an oxygen atom. Furthermore, an average molar absorption coefficient of the above-described rod-like liquid crystal compound at a wavelength of 300 to 400 nm was 140/mol·cm.

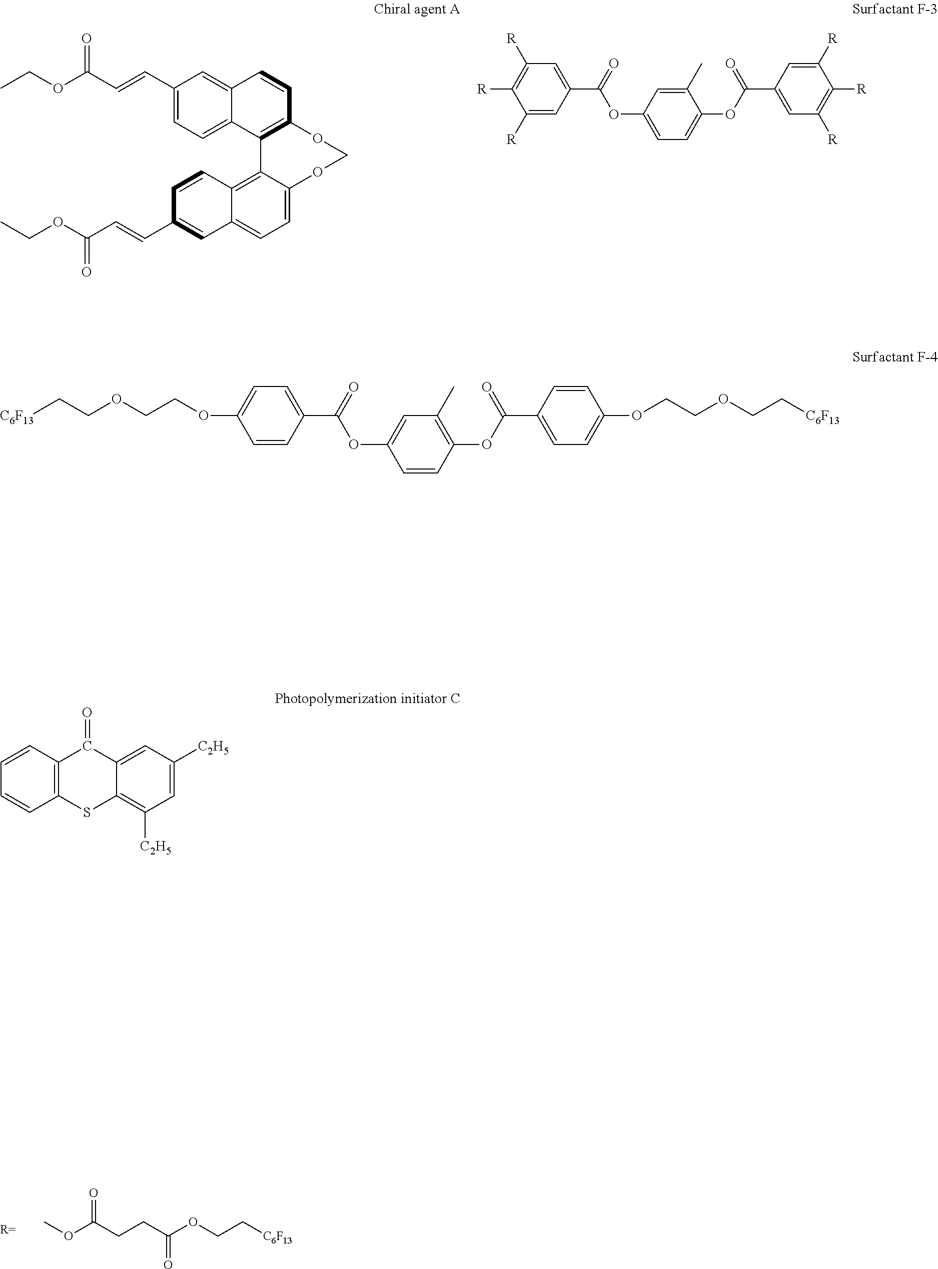

The chiral agent A was a chiral agent in which the helical twisting power (HTP) was reduced by light.

### (Coating Liquids D-2, D-3, and D-5 for Reflective Layer)

A composition shown below was stirred and dissolved in a container kept at 50° C. to prepare each of coating liquids D-2, D-3, and D-5 for a reflective layer. Here, D represents a coating liquid containing a disk-like liquid crystal compound.

Coating liquids D-2, D-3, and D-5 for reflective layer

| Disk-like liquid crystal compound (A) shown | 80 | parts by mass |
|---|---|---|
| below | | |
| Disk-like liquid crystal compound (B) shown | 20 | parts by mass |
| below | | |
| Polymerizable monomer E1 | 10 | parts by mass |
| Surfactant F-5 | 0.3 | parts by mass |
| Photopolymerization initiator (IRGACURE 907 | 3 | parts by mass |
| manufactured by BASF) | | |
| Chiral agent A | shown in Table 2 | |
| Methyl ethyl ketone | 290 | parts by mass |
| Cyclohexanone | 50 | parts by mass |

TABLE 2
Amount of chiral agent in coating liquid containing disk-like liquid crystal compound

| Coating liquid name | Type of chiral agent | Amount of chiral agent (part by mass) |
|---|---|---|
| Liquid D-2 | Chiral agent A | 5.47 |
| Liquid D-3 | Chiral agent A | 4.77 |
| Liquid D-5 | Chiral agent A | 3.97 |

Disk-like liquid crystal compound (A) 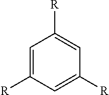 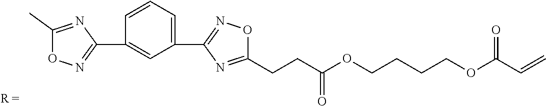 [SMILES: C=CC(=O)OCCCCOC(=O)CCc1nc(-c2cccc(-c3noc(C)n3)c2)no1]
Disk-like liquid crystal compound (B) 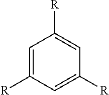 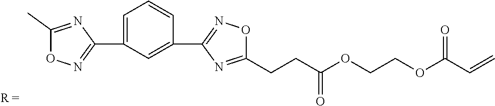 [SMILES: C=CC(=O)OCCOC(=O)CCc1nc(-c2cccc(-c3noc(C)n3)c2)no1]
Polymerizable monomer E1 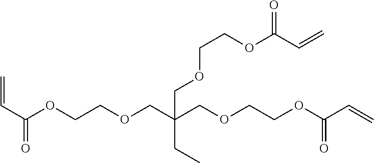 [SMILES: C=CC(=O)OCCOCC(CC)(COCCOC(=O)C=C)COCCOC(=O)C=C]
Surfactant F-5

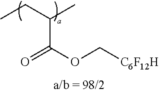

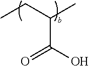

### <Coating Liquid PC-1 for Light Interference Layer>

A composition shown below was stirred and dissolved in a container held at 60° C. to prepare a coating liquid PC-1 for a light interference layer.

Coating liquid PC-1 for light interference layer

| | |
|---|---|
| Methyl isobutyl ketone | 3011.0 parts by mass |
| Mixture of rod-like liquid crystal compounds shown above | 100.0 parts by mass |
| Photopolymerization initiator G shown below | 5.1 parts by mass |
| Photoacid generator PAG-2 shown below | 3.0 parts by mass |
| Hydrophilic polymer shown below | 2.0 parts by mass |
| Vertical alignment agent shown below | 1.9 parts by mass |
| Viscosity reducing agent shown below | 4.2 parts by mass |
| Material for interlayer photo-alignment film shown below | 8.0 parts by mass |
| Stabilizer DIPEA shown above | 0.2 parts by mass |

[]Photopolymerization initiator G
[][] 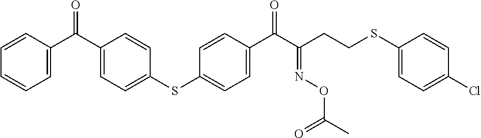 [SMILES: CC(=O)O/N=C(\CCSc1ccc(Cl)cc1)C(=O)c1ccc(Sc2ccc(C(=O)c3ccccc3)cc2)cc1] Photoacid generator PAG-2
[] 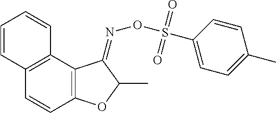 [SMILES: Cc1ccc(S(=O)(=O)O/N=C2/c3c(ccc4ccccc34)OC2C)cc1] Hydrophilic polymer 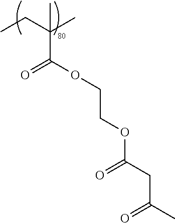 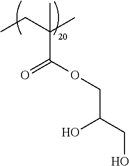
Vertical alignment agent 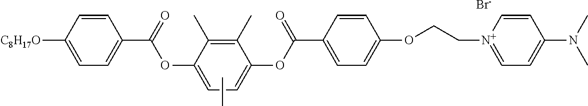
Viscosity reducing agent 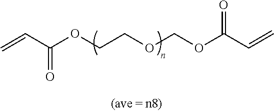
Material for interlayer photo-alignment film

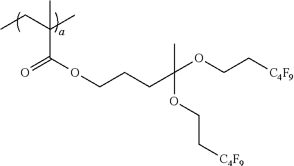

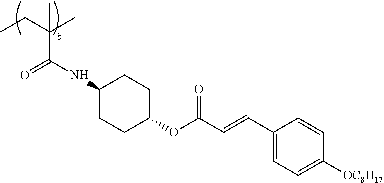

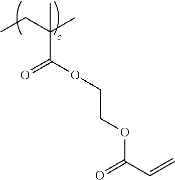

### [Production of Reflective Circular Polarizer 1]

As a temporary support, a triacetyl cellulose (TAC) film (manufactured by FUJIFILM Corporation, TG60) having a thickness of 60 μm was prepared.

The TAC film described above was coated with the coating liquid PC-1 for a light interference layer prepared above using a wire bar coater, and then dried at 80° C. for 60 seconds. Thereafter, the liquid crystal compound was cured by irradiating with light from an ultraviolet LED lamp (wavelength: 365 nm) with an irradiation amount of 300 mJ/cm² at 78° C. in a low oxygen atmosphere (100 ppm), and at the same time, a cleavage group of the material for an interlayer photo-alignment film was cleaved. Thereafter, the liquid crystal compound was heated at 115° C. for 25 seconds to eliminate a substituent containing a fluorine atom. As a result, a positive C-plate layer having a cinnamoyl group on the outermost surface and having a film thickness of 80 nm was formed. A refractive index nI measured with an interference film thickness meter OPTM (manufactured by Otsuka Electronics Co., Ltd., analyzed by a least squares method) was 1.57. Rth at a wavelength of 550 nm, which was measured with Axoscan (manufactured by Axometrics), was −8 nm.

Next, polarized UV light (wavelength: 313 nm) with an illuminance of 7 mW/cm² and an irradiation amount of 7.9 mJ/cm² was emitted from the positive C-plate side. The polarized UV light having a wavelength of 313 nm was obtained by transmitting ultraviolet light emitted from a mercury lamp through a band-pass filter having a transmission band at a wavelength of 313 nm and a wire grid type polarizing plate. The coating liquid R-1 for a reflective layer prepared as described above was applied using a wire bar coater, and dried at 110° C. for 72 seconds. Thereafter, the surface was irradiated with light using a metal halide lamp at 100° C., an illuminance of 80 mW/cm², and an irradiation amount of 500 mJ/cm² in a low oxygen atmosphere (100 ppm or less), thereby curing the coating liquid to form a first green light reflecting layer (first light reflecting layer) consisting of a cholesteric liquid crystal layer. The irradiation with light was performed from the side of the cholesteric liquid crystal layer in all cases. Here, the thickness of the coating was adjusted so that the film thickness of the cured first green light reflecting layer was 2.4 μm.

Next, the surface of the first green light reflecting layer was subjected to a corona treatment at a discharge amount of 150 W·min/m², and the surface subjected to the corona treatment was coated with the coating liquid D-2 for a reflective layer using a wire bar coater. Subsequently, the coating film was dried at 70° C. for 2 minutes and heat-aged at 115° C. for 3 minutes after the solvent was vaporized, thereby obtaining a uniform alignment state. Thereafter, the coating film was kept at 45° C. and irradiated with ultraviolet rays (300 mJ/cm²) using a metal halide lamp in a nitrogen atmosphere, thereby curing the coating film to form a second blue light reflecting layer (second light reflecting layer) on the first green light reflecting layer. The irradiation with light was performed from the side of the cholesteric liquid crystal layer in all cases. Here, the thickness of the coating was adjusted so that the film thickness of the cured second blue light reflecting layer was 1.7 μm.

Next, the second blue light reflecting layer was coated with the coating liquid D-3 for a reflective layer using a wire bar coater. Subsequently, the coating film was dried at 70° C. for 2 minutes and heat-aged at 115° C. for 3 minutes after the solvent was vaporized, thereby obtaining a uniform alignment state. Thereafter, the coating film was kept at 45° C. and irradiated with ultraviolet rays (300 mJ/cm²) using a metal halide lamp in a nitrogen atmosphere, thereby curing the coating film to form a blue light reflecting layer (third light reflecting layer) on the second blue light reflecting layer. The irradiation with light was performed from the side of the cholesteric liquid crystal layer in all cases. Here, the thickness of the coating was adjusted so that the film thickness of the cured blue light reflecting layer was 3.8 μm.

Next, the blue light reflecting layer was coated with the coating liquid R-4 for a reflective layer using a wire bar coater, and dried at 110° C. for 72 seconds. Thereafter, the surface was irradiated with light using a metal halide lamp at 100° C., an illuminance of 80 mW/cm², and an irradiation amount of 500 mJ/cm² in a low oxygen atmosphere (100 ppm or less), thereby curing the coating liquid to form a red light reflecting layer (fourth light reflecting layer) on the blue light reflecting layer. The irradiation with light was performed from the side of the cholesteric liquid crystal layer in all cases. Here, the coating thickness was adjusted so that the film thickness of the cured red light reflecting layer was 4.8 μm.

Next, the surface of the red light reflecting layer was subjected to a corona treatment at a discharge amount of 150 W·min/m², and the surface subjected to the corona treatment was coated with the coating liquid D-5 for a reflective layer using a wire bar coater. Subsequently, the coating film was dried at 70° C. for 2 minutes and heat-aged at 115° C. for 3 minutes after the solvent was vaporized, thereby obtaining a uniform alignment state. Thereafter, the coating film was kept at 45° C. and irradiated with ultraviolet rays (300 mJ/cm²) using a metal halide lamp in a nitrogen atmosphere, thereby curing the coating film to form a yellow light reflecting layer (fifth light reflecting layer) on the red light reflecting layer. The irradiation with light was performed from the side of the cholesteric liquid crystal layer in all cases. Here, the thickness of the coating was adjusted so that the film thickness of the cured yellow light reflecting layer was 3.3 μm.

In this manner, a reflective circular polarizer 1 including reflective layers in which a cholesteric liquid crystalline phase was fixed was produced on the temporary support.

Table 3 shows the reflection center wavelength and the film thickness of each of the reflective layers of the produced reflective circular polarizer 1. Here, the reflection center wavelength was used to define characteristics of a light reflection film having a reflection band formed of a cholesteric liquid crystal, and referred to the middle point of a spectral band reflected by the film. Specifically, the reflection center wavelength was obtained by calculating the average value of the wavelengths on the short wavelength side and the wavelengths on the long wavelength side which show the half value of the peak reflectivity. A reflection center wavelength (central wavelength of reflected light) was confirmed by producing a film obtained by applying only a single layer. The film thickness was confirmed with a scanning electron microscope (SEM).

TABLE 3
Characteristics of light reflecting layers
of reflective circular polarizer 1

| | | | Reflection | |
|---|---|---|---|---|
| | Coating | Amount of | center | Film |
| | liquid | chiral agent | wavelength | thickness |
| | name | (part by mass) | (nm) | (μm) |
| Fifth layer | Liquid R-1 | 3.51 | 566 | 2.4 |
| Fourth layer | Liquid D-2 | 5.47 | 446 | 1.7 |
| Third layer | Liquid D-3 | 4.77 | 508 | 3.8 |
| Second layer | Liquid R-4 | 2.9 | 675 | 4.8 |
| First layer | Liquid D-5 | 3.97 | 605 | 3.3 |

In a case where the temporary support was peeled off from the produced reflective circular polarizer 1, and a glass transition temperature of the reflective circular polarizer 1 was measured using a dynamic viscoelasticity measuring device (DVA-200 manufactured by IT Measurement & Control Co., Ltd.), the glass transition temperature was 98° C.

In addition, at a temperature higher than the glass transition temperature by 20° C., that is, at 118° C., a dimensional change in a case where the reflective circular polarizer 1 was heated for 1 minute was a contraction of 0.6% in all orientations.

### [Preparation of Reflective Linear Polarizer 1]

In a case where a tablet computer “iPad (registered trademark)” manufactured by Apple Inc. was disassembled and a liquid crystal panel was taken out, a polarizing plate including a reflective linear polarizer was bonded to a back surface of the liquid crystal panel. The polarizing plate was peeled off from the liquid crystal panel, and the peeled polarizing plate was immersed in water at 80° C. for 1 minute to peel off only the reflective linear polarizer.

The obtained reflective linear polarizer was used as a reflective linear polarizer 1.

A part of the reflective linear polarizer 1 was cut out, and a cross section in the thickness direction was observed with a SEM. As a result, the reflective linear polarizer 1 was a reflective linear polarizer in which two or more types of birefringent layers were alternately laminated. In addition, a thickness of the reflective linear polarizer 1 was 17 μm.

In a case where the reflective linear polarizer 1 was measured using a dynamic viscoelasticity measuring device (“DVA-200” manufactured by IT Measurement & Control Co., Ltd.), a glass transition temperature of the reflective linear polarizer 1 was 98° C.

In addition, at a temperature higher than the glass transition temperature by 20° C., that is, at 118° C., a dimensional change in a case where the reflective linear polarizer 1 was heated for 1 minute was a contraction of 1.1% in an orientation of a reflection axis. In addition, the dimensional change of the reflective linear polarizer 1 in a case of heating at 118° C. for 1 minute was an expansion of 1.0% in an orientation of a transmission axis.

### [Preparation of Reflective Linear Polarizer 2]

Since the dimensional change of the reflective linear polarizer 1 was more than 0.8%, the reflective linear polarizer 1 was heated at 140° C. for 5 minutes and contracted in all orientations including the orientation of the reflection axis. The reflective linear polarizer thus obtained was used as a reflective linear polarizer 2. The dimensional change in a case where the reflective linear polarizer 2 was heated at 118° C. for 1 minute was a contraction of 0.1% in the orientation of the reflection axis. In addition, the dimensional change of the reflective linear polarizer 2 in a case of heating at 118° C. for 1 minute was a contraction of more than 0% and less than 0.1% in all orientations.

### Reference Example 1

### [Production of Optical Laminate 1]

A PMMA film “TECHNOLLOY S001G” manufactured by Sumika Acryl Co., Ltd. was coated with an ultraviolet curable adhesive “ARONIX (registered trademark) UVX-6282” manufactured by Toagosci Co., Ltd. Next, the above-described absorptive polarizer 1 was bonded to a coating film of the ultraviolet curable adhesive, and then irradiated with ultraviolet rays (300 mJ/cm²) to cure the adhesive, thereby bonding the PMMA film and the absorptive polarizer 1. The cellulose acylate film 1 used as the temporary support (transparent support) of the absorptive polarizer 1 was peeled off and removed after the bonding. In the bonded absorptive polarizer 1, the barrier layer B1, the light absorption anisotropic film P1, and the photo-alignment film PA1 were disposed from the coating film side of the ultraviolet curable adhesive.

In the same manner as described above, the λ/4 retardation plate 1 and the reflective circular polarizer 1 were further bonded to the absorptive polarizer 1 in this order. The temporary support included in the λ/4 retardation plate 1 and the temporary support included in the reflective circular polarizer 1 were peeled off and removed from the laminate after the bonding.

Next, a pressure sensitive adhesive sheet “NCF-D692 (5)” manufactured by LINTEC Corporation was bonded to the reflective circular polarizer 1, and then an antireflection film “AR200-T0810-JD” manufactured by Dexerials Corporation was bonded thereto. Furthermore, a pressure sensitive adhesive sheet “NCF-D692 (15)” manufactured by LINTEC Corporation was bonded to the above-described PMMA film “TECHNOLLOY S001G”.

In this way, an optical laminate 1 of Reference Example 1 was obtained.

A storage elastic modulus G′ of the pressure sensitive adhesive sheet measured by the torsional shear method, which was measured by the above-described method, was 3.2 MPa.

In the optical laminate 1 of Reference Example 1, the pressure sensitive adhesive sheet, the PMMA film, the adhesive layer, the absorptive polarizer 1, the adhesive layer, the λ/4 retardation plate 1, the adhesive layer, the reflective circular polarizer 1, the pressure sensitive adhesive sheet, and the antireflection film were arranged in this order.

In addition, the λ/4 retardation plate 1 and the absorptive polarizer 1 were disposed such that an orientation of a slow axis of the λ/4 retardation plate 1 formed an angle of 45° with an orientation of an absorption axis of the absorptive polarizer 1.

### [Production of Virtual Reality Display Apparatus 1]

A virtual reality display apparatus “VIVE FLOW (registered trademark)” manufactured by HTC Corporation was disassembled, and an optical lens was taken out from a lens barrel. The “VIVE FLOW” is a virtual reality display apparatus in which a pancake lens is adopted, and a liquid crystal display device which emits circularly polarized light by a polarizing plate bonded to a surface is used as an image display device.

In addition, the taken optical lens was two types of lenses, one of which was a biconvex lens having a half-mirror coating on one surface and the other of which was a plano-convex lens having an optical laminate bonded to a plane.

Next, the optical laminate 1 was bonded to a plane portion of a plano-convex lens “#45-151” manufactured by Edmund Optics Inc. such that the pressure sensitive adhesive sheet on the surface of the optical laminate 1 was in contact with the plane portion. The obtained plano-convex lens with the optical laminate 1 was heated at 115° C. for 5 minutes to strengthen the adhesion between the optical laminate 1 and the plano-convex lens.

The obtained plano-convex lens with the optical laminate 1 was assembled to a lens barrel of “VIVE FLOW” instead of a plano-convex lens of “VIVE FLOW”, and the previously removed biconvex lens with the half mirror coating was assembled to the lens barrel, thereby producing a virtual reality display apparatus 1 of Reference Example 1.

### Example 1

### [Production of Optical Laminate 2]

A PMMA film “TECHNOLLOY S001G” manufactured by Sumika Acryl Co., Ltd. was coated with an ultraviolet curable adhesive “ARONIX UVX-6282” manufactured by Toagosci Co., Ltd., the above-described absorptive polarizer 1 was bonded to the coating film of the ultraviolet curable adhesive, and the adhesive was cured by further irradiating with ultraviolet rays (300 mJ/cm²), thereby bonding the PMMA film and the absorptive polarizer 1. The cellulose acylate film used as the temporary support (transparent support) of the absorptive polarizer 1 was peeled off and removed after the bonding. In the bonded absorptive polarizer 1, the barrier layer B1, the light absorption anisotropic film P1, and the photo-alignment film PA1 were disposed from the coating film side of the ultraviolet curable adhesive.

In the same manner as described above, the reflective linear polarizer 2 and the λ/4 retardation plate 1 were further bonded to the absorptive polarizer 1 in this order. The temporary support included in the λ/4 retardation plate 1 was peeled off and removed from the laminate after the bonding.

Next, a pressure sensitive adhesive sheet “NCF-D692 (5)” manufactured by LINTEC Corporation was bonded to the λ/4 retardation plate 1, and then an antireflection film “AR200-T0810-JD” manufactured by Dexerials Corporation was bonded thereto. Furthermore, a pressure sensitive adhesive sheet “NCF-D692 (15)” manufactured by LINTEC Corporation was bonded to the above-described PMMA film “TECHNOLLOY S001G”.

In this way, an optical laminate 2 of Example 1 was obtained.

In the optical laminate 2 of Example 1, the pressure sensitive adhesive sheet, the PMMA film, the adhesive layer, the absorptive polarizer 1, the adhesive layer, the reflective linear polarizer 2, the adhesive layer, the λ/4 retardation plate 1, the pressure sensitive adhesive sheet, and the antireflection film were arranged in this order.

In addition, the absorptive polarizer 1 and the reflective linear polarizer 2 were disposed such that the orientation of the absorption axis of the absorptive polarizer 1 and the orientation of the reflection axis of the reflective linear polarizer 2 were parallel to each other; and the reflective linear polarizer 2 and the λ/4 retardation plate 1 were disposed such that the orientation of the reflection axis of the reflective linear polarizer 2 and the orientation of the slow axis of the λ/4 retardation plate 1 formed an angle of 45°.

### [Production of Virtual Reality Display Apparatus 2]

A virtual reality display apparatus 2 of Example 1 was produced in the same manner as in Reference Example 1, except that the optical laminate 2 was bonded to the plane portion of the plano-convex lens “#45-151” (manufactured by Edmund Optics Inc.) instead of the optical laminate 1.

### Comparative Example 1

### [Production of Optical Laminate 3]

An optical laminate 3 of Comparative Example 1 was produced in the same manner as the production method of the optical laminate 2, except that the reflective linear polarizer 2 was used instead of the reflective linear polarizer 1.

### [Production of Virtual Reality Display Apparatus 3]

A virtual reality display apparatus 3 of Comparative Example 1 was produced in the same manner as in Reference Example 1, except that the optical laminate 3 was bonded to the plane portion of the plano-convex lens “#45-151” (manufactured by Edmund Optics Inc.) instead of the optical laminate 1.

### Example 2

### [Production of Virtual Reality Display Apparatus 4]

The optical laminate 2 was bonded to a concave surface side of a convex meniscus lens “LE1076-A” (diameter: 2 inches, focal length: 100 mm, curvature radius of concave surface side: 65 mm) manufactured by Thorlabs, Inc. such that the pressure sensitive adhesive sheet on the surface of the optical laminate 2 was in contact with the concave surface of the convex meniscus lens. The obtained lens with the optical laminate 2 was heated at 115° C. for 5 minutes to strengthen the adhesion between the optical laminate 2 and the lens.

The optical laminate 2 was bonded to the concave surface of the convex meniscus lens by a known vacuum forming method. Specifically, the optical laminate 2 was bonded to the concave surface of the convex meniscus lens with reference to JP3733564B.

The obtained lens with the optical laminate 2 was attached to a lens barrel of “VIVE FLOW” instead of the plano-convex lens of “VIVE FLOW”. In this case, the lens was installed such that the concave surface side of the lens was the visible side. In addition, a virtual reality display apparatus 4 of Example 2 was produced by attaching the previously removed biconvex lens with the half mirror coating to the above-described lens barrel.

### [Evaluation of Image Sharpness]

In the virtual reality display apparatuses produced in Reference Examples 1, Example 1, Example 2, and Comparative Example 1, a black-and-white checker pattern was displayed on the image display device, and a degree of image sharpness was evaluated by visual observation in the following three stages. In a case where the image sharpness was deteriorated, a part or the entirety of the checkered pattern appeared distorted.

A: distortion of the checkered pattern was not substantially recognized.

B: distortion of the checkered pattern was slightly recognized, but it was not noticeable in a case where the display image was visually recognized.

C: distortion of the checkered pattern was clearly recognized.

The evaluation results of the image sharpness are shown in Table 4.

TABLE 4
Evaluation results of virtual reality display apparatuses
of Reference Example, Examples, and Comparative Example

| | Optical laminate | Image sharpness |
|---|---|---|
| Reference Example 1 | Optical laminate 1 | A |
| Example 1 | Optical laminate 2 | A |
| Comparative Example 1 | Optical laminate 3 | C |
| Example 2 | Optical laminate 2 | A |

As can be seen from Table 1, the virtual reality display apparatuses of Examples 1 and 2 had higher image sharpness than that of Comparative Example 1. It is presumed that, in the virtual reality display apparatuses of Examples 1 and 2, the smoothness of the optical laminate was further improved as a result of the sufficiently small dimensional change of the reflective polarizer in the optical laminate due to heating.

The virtual reality display apparatus according to the embodiment of the present invention has been described in detail above, but the present invention is not limited to the above-described examples, and various improvements and changes may be made without departing from the spirit of the present invention.

### EXPLANATION OF REFERENCES

100: optical laminate
300: half mirror
400: circular polarizer
500: image display panel
1000: ray forming virtual image

What is claimed is:

1. An optical laminate comprising:
a reflective polarizer;
an absorptive polarizer; and
adhesive layers,
wherein, in a case where the reflective polarizer is heated for 1 minute at a temperature higher than a glass transition temperature of the reflective polarizer by 20° C., the reflective polarizer exhibits a dimensional change of a contraction of 0% or more and less than 0.8% in at least one in-plane orientation, and
the reflective polarizer is a reflective linear polarizer formed by alternately laminating two or more different types of birefringent layers.

2. The optical laminate according to claim 1,
wherein the absorptive polarizer includes an anisotropic absorption layer containing at least a liquid crystal compound and a dichroic coloring agent.

3. The optical laminate according to claim 1,
wherein at least one of the adhesive layers is a layer consisting of a pressure sensitive adhesive sheet, and
the pressure sensitive adhesive sheet has a storage elastic modulus G′ of 0.8 MPa or more, which is measured by a torsional shear method at 20° C.

4. The optical laminate according to claim 1,
wherein at least one of the adhesive layers is a layer formed by curing a composition for forming an adhesive layer, which contains an ultraviolet curable adhesive.

5. The optical laminate according to claim 1, further comprising:
at least one λ/4 retardation plate.

6. The optical laminate according to claim 5,
wherein the λ/4 retardation plate is formed by fixing a liquid crystal phase.

7. The optical laminate according to claim 1,
wherein, in a case where the reflective polarizer is heated for 1 minute at a temperature higher than a glass transition temperature of the reflective polarizer by 20° C., the reflective polarizer exhibits a dimensional change of a contraction of 0% or more and less than 0.1% in all in-plane orientations.

8. The optical laminate according to claim 1,
wherein the glass transition temperature of the reflective polarizer is 95° C. or higher.

9. The optical laminate according to claim 1,
wherein, in a case where the reflective polarizer is heated for 1 minute at a temperature higher than a glass transition temperature of the reflective polarizer by 20° C., the reflective polarizer exhibits a dimensional change of a contraction of 0% or more and less than 0.1% in all in-plane orientations, and
the glass transition temperature of the reflective polarizer is 95° C. or higher.

10. An optical lens having a curved surface portion,
wherein the optical laminate according to claim 1 is bonded to the curved surface portion.

11. A virtual reality display apparatus comprising:
an image display apparatus which emits polarized light;
a half mirror having a curved surface portion; and
the optical lens according to claim 10.

12. The optical laminate according to claim 2,
wherein at least one of the adhesive layers is a layer consisting of a pressure sensitive adhesive sheet, and
the pressure sensitive adhesive sheet has a storage elastic modulus G′ of 0.8 MPa or more, which is measured by a torsional shear method at 20° C.

13. The optical laminate according to claim 2,
wherein at least one of the adhesive layers is a layer formed by curing a composition for forming an adhesive layer, which contains an ultraviolet curable adhesive.

14. The optical laminate according to claim 2, further comprising:
at least one λ/4 retardation plate.

15. The optical laminate according to claim 14,
wherein the λ/4 retardation plate is formed by fixing a liquid crystal phase.

16. The optical laminate according to claim 2,
wherein, in a case where the reflective polarizer is heated for 1 minute at a temperature higher than a glass transition temperature of the reflective polarizer by 20° C., the reflective polarizer exhibits a dimensional change of a contraction of 0% or more and less than 0.1% in all in-plane orientations.

17. The optical laminate according to claim 2,
wherein the glass transition temperature of the reflective polarizer is 95° C. or higher.

18. The optical laminate according to claim 2,
wherein, in a case where the reflective polarizer is heated for 1 minute at a temperature higher than a glass transition temperature of the reflective polarizer by 20° C., the reflective polarizer exhibits a dimensional change of a contraction of 0% or more and less than 0.1% in all in-plane orientations, and
the glass transition temperature of the reflective polarizer is 95° C. or higher.

19. An optical lens having a curved surface portion,
wherein the optical laminate according to claim 2 is bonded to the curved surface portion.

20. A virtual reality display apparatus comprising:
an image display apparatus which emits polarized light;
a half mirror having a curved surface portion; and
the optical lens according to claim 19.
